(19) United States
(12) Patent Application Publication
(10) Pub. No.: US 2008/0028988 A1
(43) Pub. Date: Feb. 7, 2008

(54) Method and apparatus for making air-entrained or cellular high-strengthconcrete

(76) Inventor: Charles David Welker, Richardson, TX (US)

Correspondence Address: David E. Orr, 4616 NE 134th Street, Vancouver, WA, 98686, US

(21) Appl. No.: 11/709,932

(22) Filed: Feb. 21, 2007

Related U.S. Application Data
(60) Provisional application No. 60/775,571, filed on Feb. 21, 2006.

(51) Int. Cl. B01F 15/02

(52) U.S. Cl. 106/316; 366/151.1; 366/153.1

(57) ABSTRACT

A method for making foam used in the manufacture of concrete, the method comprising, in an exemplary embodiment for making foam at the rate of one cubic foot per minute; (1) injecting water into a mixer, the water injected at a temperature not less than 62 degrees Fahrenheit, the water injected at the rate from 252 ounces per minute to 1,178 ounces per minute; (3) injecting a chemical into the mixer, wherein the chemical comprises a surfactant, a foam booster and a stabilizer, the chemical injected at a temperature of not less than 52 degrees Fahrenheit and at a rate of 22 ounces to 79 ounces per minute; and (4) injecting air into the mixer, the air injected at a pressure from 62 pounds-per-square inch to 135 pounds-per-square inch, and at the rate of from 19 cubic feet per minute to 32 cubic feet per minute; whereby foam is made in the mixer, and may be later used in the manufacture of concrete.

### RELATED APPLICATIONS

This application is related to and derives priority from U.S. provisional application 60/775,571, filed Feb. 21, 2006.

### FIELD

The present invention is a process for the manufacture of air entrained or cellular concrete, while maintaining concrete strength; more specifically the present invention relates to a process for making foams, which are added to concrete mixes used to make air-entrained concrete. An apparatus is also disclosed for implementing the process.

### BACKGROUND

Concrete is a composite material comprised of water, cement, and aggregate. Common aggregates include sand, gravel, or stones. Concrete may also contain various additives, which may enhance or modify its basic attributes. Concrete is a well-known structural component with typical structural compressive strengths of approximately 2500 or more pounds per square inch. More detailed discussions regarding concrete and its properties can be found in Concrete, by S. Mindess and J. F. Young (Prentice Hall, Inc, Englewood Cliffs, N.J. 1981), in Design and Control of Concrete Mixtures, 14th Ed., by S. H. Kosmatka, B. Kerkhoff, and W. C. Panarese (Portland Cement Association, Skokie, Ill., 2002), and in the ACI Manual of Concrete Practice (American Concrete Institute, 1987). There are numerous concrete applications where engineering the exact amount of air may be suitable, useful, or desirable, especially when combined with other attributes such as better processing, higher strength to weight ratio, improved insulation properties, and or enhanced acoustic properties, flow properties and compaction properties.

### SUMMARY

According to the need for better systems and methods for making high-strength, air entrained or cellular concrete herein is disclosed in an exemplary embodiment a method for making foam used to manufacture concrete. The method comprises, in an exemplary embodiment for making foam at the rate of one cubic foot per minute; (1) injecting water into a mixer, the water injected at a temperature not less than 62 degrees Fahrenheit, the water injected at the rate from 252 ounces per minute to 1178 ounces per minute; (3) injecting a chemical into the mixer, wherein the chemical comprises a surfactant, a foam booster and a stabilizer, the chemical injected at a temperature of not less than 52 degrees Fahrenheit at a rate of from 22 ounces per minute to 79 ounces per minute; and (4) injecting air into the mixer, the air injected at a pressure from 62 pounds-per-square inch to 135 pounds-per-square inch, and at the rate of from 19 cubic feet per minute to 32 cubic feet per minute; whereby said foam is made in the mixer, and may be later used in the manufacture of concrete.

In an exemplary embodiment an apparatus for implementing the method, the apparatus comprising a mixer for mixing, holding, and delivering said foam, the foam delivered from the mixer according to a first control. The apparatus further includes an air container storing air, the air container made to hold and convey air to the mixer according to a second control. The apparatus also has a chemical store, the chemical store made to hold and convey chemical to the mixing device according to a third control and also has a water store, the water store made to hold and convey water to the mixer according to a fourth control. The apparatus further has a controller for controlling air pressure in the air store, water temperature in the water container and for generating said first, second, third and fourth controls, whereby the controller generates the first, second and third controls to deliver air, water and chemical to the mixer and make said foam, and the fourth control to deliver foam from the apparatus. The controller with controls are configured to store and deliver constituents used to make at the rates and temperatures previously recited.

Various configurations of the apparatus may be employed, wherein portions of the apparatus may be replicated in order to achieve reliability in the case of equipment malfunction, or in order to increase production rates or volumes of foam made.

The apparatus, by combining water and chemical makes an aqueous solution comprising a surfactant, a foam booster and a stabilizer. The aqueous solution is combined with air to make foam that is uniform and stable, and which may be used to make air-entrained concrete.

The apparatus shown and described below is exemplary with numerous possible variations. The apparatus described below, or variant of the apparatus described below implements the method for making foam found efficacious to manufacturing high-strength, air entrained or cellular concrete. In general an apparatus implementing the method is configured to: (1) provide a mixer for mixing air, water and chemical to produce said foam; (2) provide and convey air to the mixer; (3) provide and convey a chemical to the mixer; (4) provide water to the mixer; and (5) provide a controller to control storage and release of air, water and chemical as constituents, and to control physical properties of the constituents, such as flow rates and temperatures recited above, and to convey constituents to the mixer, in the proper rates with the desired properties, where foam is made, and to control the release of foam in the mixer, said foam efficacious to the manufacture of high-strength, low-density concrete.

The apparatus and method provide several benefits and advantages; among those are the foam made comprises air bubbles of a remarkably uniform size and dispersion, when used in the manufacture of concrete.

Another benefit and advantage is the foam is unusually stable, when compared to foam made by prior art devices and methods.

The benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF THE DRAWINGS

FIG. 1 shows a functional diagram of an apparatus that executes or implements the exemplary embodiment of the invention.

FIG. 2 is a flow diagram of the method implemented by the exemplary embodiment.

FIG. 3 is a diagram of a computer that may be used to control the apparatus of the exemplary embodiment.

### LABELING IN THE DRAWINGS

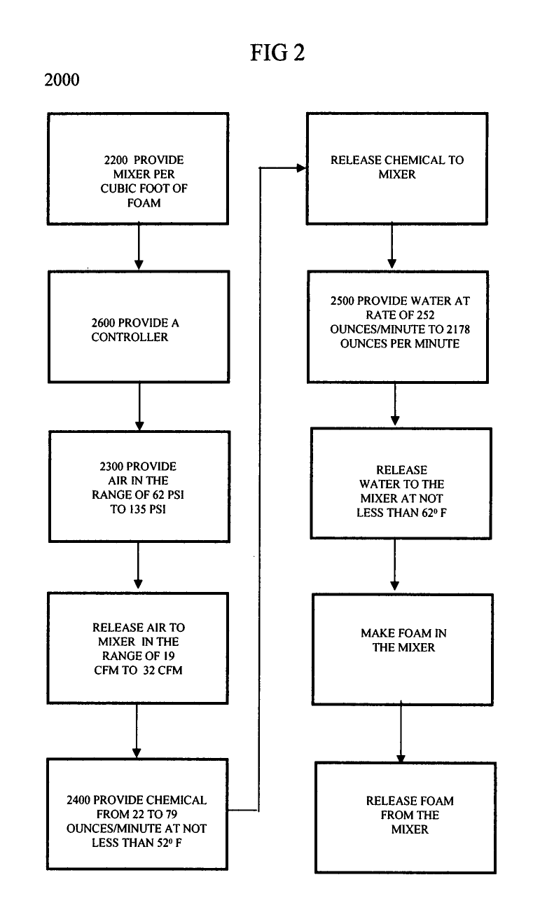

In the drawings each component or feature of the apparatus implementing the exemplary method will be labeled with a four-digit label. The first digit corresponds to the drawing or FIG number. For example, all components or features in FIG. 2 will be labeled as 2xxx, where xxx is the label of the component or feature appearing in FIG. 2. The following labels are assigned to components or features:

000 apparatus or method of the exemplary embodiment

200 mixer

250 mixer dispersing device

300 air source having air

320 control mechanism for receiving signal to control holding and release of air from air source

500 water source having water

520 control mechanism for receiving signal to control holding and release of water from source

400 chemical source having chemical

420 control mechanism for receiving signal to control holding and release of chemical from source

700 computer

710 CPU

720 software

730 memory

740 storage

750 input device

760 output device

770 communications devices

600 controller

### DETAILED DESCRIPTION

Useful compositions of air entrained or cellular concrete are produced by the introduction of solid aggregates of lower density, by incorporating significant amounts of air or other gas, or by a combination of these methods such as including expanded polystyrene or other polymer foam. Structural lightweight concrete compositions (85-115 pounds per cubic foot) are most commonly prepared using lightweight aggregates (35-70 pounds per cubic foot, as compared to 75-110 pounds per cubic foot for normal weight aggregates) such as kiln expanded clays, shales, and slates; sintering grade expanded shales and slates; pellets or extruded fly-ash; and expanded slags. The use of these lightweight aggregates is constrained by their lower limit of density, their availability, phase separation or non-uniformity upon curing, as well the high cost associated with material, fuel, labor, processing, and transportation.

Concrete, in which voids of air or other gases are substituted for at least some of the aggregates is known variously as aerated, air-entrained, or cellular concrete. Although the three names are generally used interchangeably, the name “air-entrained” will be used exclusively, hereinafter, for the sake of brevity. Given the inherently low density of gasses and their relative abundance and ease of generation, their incorporation can have significant advantages for lowering the density of concrete. There are two fundamentally different approaches to incorporating air or other low-density gasses. One approach generates gas in-situ by chemical reaction and the other approach generates small pockets of air or gas either by whipping the concrete or by including preformed bubbles or foam into the wet mix before curing.

In-situ generation of gas typically involves the production of hydrogen gas from the base catalyzed reaction of a finely divided reactive metal species such as aluminum. This approach requires uniform premixing, fine control of many processing parameters, and significant capital investment for dedicated special equipment. Other drawbacks to this approach may include the use of autoclaves to cure the concrete under pressurized hydrothermal conditions, the need for molds or other types of undesirable processing steps, and limited vertical uniformity (usually less than two feet). Large shapes or complicated designs are usually precluded from this approach.

Although creating air bubbles within reduces concrete density, the process may not be practical, as it is difficult to control. The generation of foams separately, using surfactants and other foaming agents in combination with water and air, and then subsequently introducing the foams into a premixed paste of cement, water, and aggregate, is a much more effective method for producing air-entrained or cellular concrete.

Previously, economical and convenient surfactant based foams used in concrete have not maintained their structures and volumes for required mixing cycles. Despite many advantages, concrete compositions including foam aggregates have often been limited to insulating, non-structural, or non-load-bearing bearing applications, since most commercially available foaming agents are not sufficiently stable in cementitious media and the results are often not consistent. In the previous art, the size and distribution of foam cells have been difficult to control and the cells have had a limited period of usefulness or lifetime. The foam cells have tended to agglomerate, coalesce, and recombine to give larger cells and a wide range of sizes. Long mixing times, such as required for transportation from a concrete production facility to a construction site, have been precluded due to bubbles collapsing and air escaping from the mix. Even when additives have been used to stabilize these foams, it is not always practical to add the foam to the cementitious mix at the batch plant, as the foam's stability and useful lifetime may be very limited. Prior art methods alter the cure speed to match the foam's useful lifetime using accelerators, retardants, and autoclaving. These methods are not trivial and impractical for many targeted applications.

An Apparatus for Practicing the Exemplary Embodiment

An exemplary apparatus for making foam used to manufacture concrete comprises (1) a mixer for mixing, holding, and delivering said foam, the foam delivered from the mixer according to a first control; (2) an air container storing air, the air container made and convey air to the mixer according to a second control; (3) a chemical store, the chemical store made to hold and convey chemical to the mixing device according to a third control; (4) a water store, the water store made to hold and convey water to the mixer according to a fourth control; and (5) a controller for controlling air pressure in the air store, water temperature in the water container and for generating said first, second, third and fourth controls, whereby the controller generates the first, second and third controls to deliver air, water and chemical to the mixer and make said foam, and the fourth control to deliver foam from the apparatus.

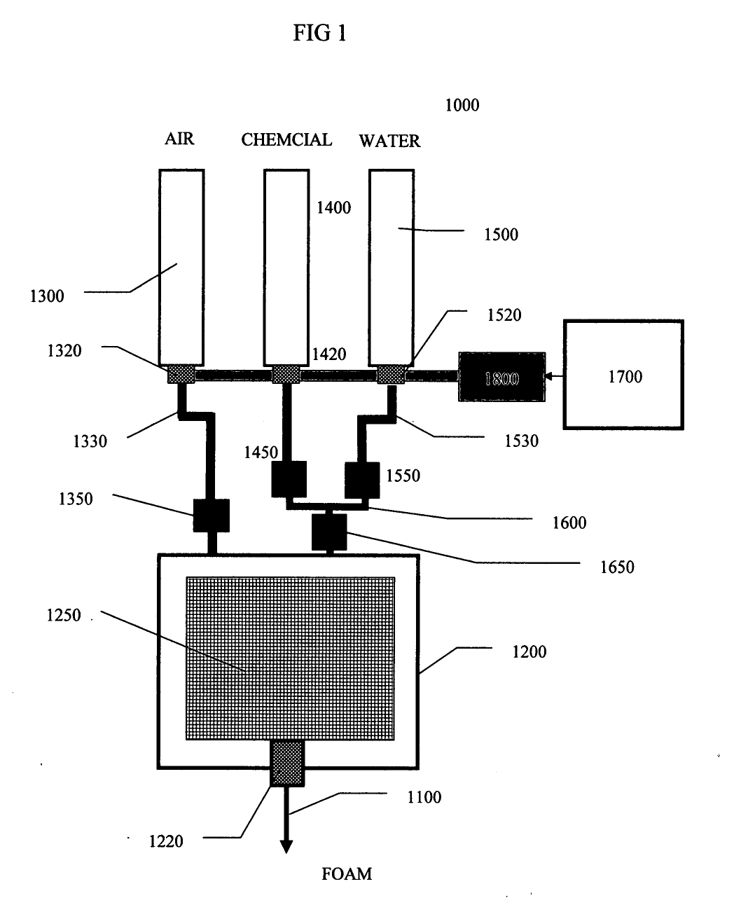

FIG. 1 shows an exemplary apparatus 1000 for making foam 1100 used to manufacture concrete. The exemplary apparatus 1000 comprises a mixer 1200 for mixing, holding, and delivering foam 1100, the foam 1100 delivered from the mixer 1200 according to a first control 1220. The mixer 1200 comprises a chamber having a dispersing mechanism 1250. The apparatus 1000 further includes an air container 1300 storing air 1310, the air container 1300 made to hold and convey air to the mixer 1200 according to a second control 1320. The apparatus 1000 also has a chemical store 1400, the chemical store 1400 made to hold and convey chemical to the mixer 1200 according to a third control 1420 and also has a water store 1500, the water store 1500 made to hold and convey water to the mixer according to a fourth control 1520. The apparatus 1000 further has a controller 1600 for controlling air pressure in the air store 1300, water temperature in the water store 1500 and for generating said first, second, third and fourth controls 1220 1320 1420 1520, whereby the controller 1600 generates the second, third and fourth controls 1220 1320 1420 to deliver air 1310, water 1510 and chemical 1410 to the mixer 1200 and make said foam 1100, and the first control 1220 to deliver foam 1100 from the apparatus 1000. The apparatus 1000 may also use a computer 1700 to manage and to control the apparatus 1000.

In the following disclosure, volumes, and flow rates of foam constituents will be recited. These volumes and flow rates assume a foam production rate of one (1) cubic foot per minute. For higher or lower foam production rates, volumes and constituent flow rates are adjusted accordingly.

In the apparatus 1100 implementing the method for making foam, the controller 1600 maintains and controls air, water and chemical in a preferred set of operational ranges. For example, air in the air storage 1300 and releases, by the second control mechanism 1320, air at a pressure in the range from 62 PSI (pounds per square inch) to 135 PSI, and in a released volume of from 19 cubic feet per minute to 32 cubic feet per minute. The controller 1600 controls, maintains, and releases, by the third control mechanism 1420, chemical in the chemical store 1400, the chemical maintained and released at a rate from 22 ounces per minute to 79 ounces per minute and at a temperature not less than 52 degrees Fahrenheit. Chemical in the chemical store comprises a surfactant, a foam booster, and a stabilizer. The controller 1600 controls, maintains and releases water from the water store in the range of from 252 ounces per minute to 1178 ounces per minute, and at a temperature not less than 59 degrees Fahrenheit.

More specifically, using the exemplary apparatus, foam is made by introducing pressurized air into an aqueous solution comprising a chemical comprising at least one surfactant, at least one foam booster, and at least one stabilizer. Again with reference to FIG. 1, the exemplary apparatus 1000 for making and dispensing the foam, may have redundant parts for reliability, and includes a reservoir 1300 for storing water; a chemical storage tank 1400 for storing chemical comprising surfactant(s), foam booster(s) and stabilizer(s); a mixer 1200 having a dispensing tank for aqueous solution mixing and dispensing and into which the chemical is delivered from the chemical storage tank 1400 by a metering pump 1450 through a supply conduit 1430 to the mixer 1200; a first water delivery conduit 1530 which supplies water to a first metering pump 1550 for metering into the mixer 1200; a chemical delivery conduit 1430; and optionally (not shown) a second water delivery conduit which delivers water from a second water metering pump to a combining conduit for ultimate delivery into the mixer 1200; (optionally) a second chemical delivery conduit which delivers chemical from the second metering pump to a combining conduit 1600, where the chemical is mixed with water in desired proportions; a first normally-closed discharge valve 1620, which controls the discharge of the water/concentrate mixture from the combining conduit 1600; a supply of pressure-regulated compressed air; a second normally-closed discharge valve 1350, which controls the discharge of compressed air; and, within the mixer 1200, a stainless-steel-wool-filled mixing chamber 1250, which receives a desired quantity of the water/chemical mixture through the first discharge valve 1650, and a desired quantity of pressure-regulated compressed air through the second discharge valve 1350, thereby resulting in aeration of the desired quantity of concentrate to produce a desired quantity of foam having a desired set of physical properties. Water entering the water storage reservoir preferably first passes through a filter, which removes most particular matter so that the reservoir does not rapidly fill with sediment. Water within the reservoir is maintained at a temperature within the preferred range by one or more heaters and located within the reservoir and one or more pumps, which cause the water within the reservoir to circulate over the heaters. The first and second metering pumps 1350 1550, respectively, are preferably enclosed in a chamber, where they are maintained at a temperature within a desired range by heating and cooling equipment. For a currently preferred embodiment of the invention, the apparatus for generating and dispensing foam has two separate paths for producing the foam. Various other parts or components of the apparatus may be replicated in order to achieve operational reliability or to increase the rates of foam made.

Method of the Apparatus

With reference to FIG. 2, the apparatus implements a method 2000 for making foam efficacious to manufacturing high-strength, air entrained or cellular concrete. This method comprises: 2200 providing a mixer for mixing air, water and chemical, in an aqueous solution, to produce said foam, the method comprising: 2600 providing a controller to control the process implemented by the apparatus, that is to control the operational ranges that are preferred and desired, and to control storing and release of constituents into the mixer; and 2300 providing air; 2400 providing chemical; and 2500 providing water; and by the controller 2600 controlling the properties of air, water and chemical and their conveyance to the mixer, whereby said air, water and chemical to the mixer, where is made in the mixer, said foam efficacious to the manufacture of high-strength, air entrained or cellular concrete, and said foam is released to be used in concrete.

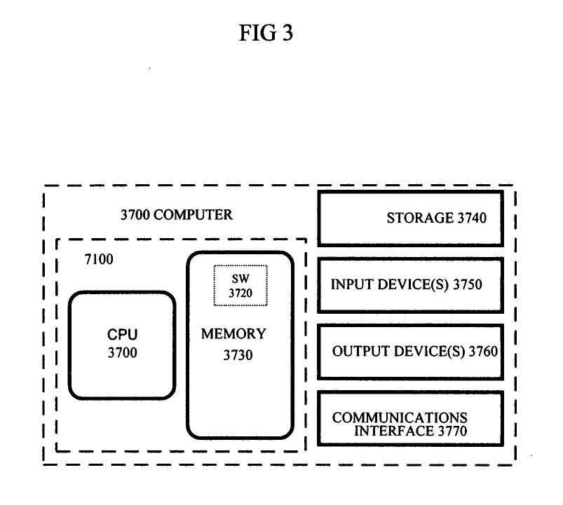

With reference to FIG. 3, control of the exemplary embodiment may be implemented; for example, within a computing environment 3000, which includes at least one processing unit 3700 and memory 3730. In FIG. 3, this most basic configuration 3000 is included within a dashed line. The processing unit 3700 executes computer-executable instructions and may be a real or a virtual processor. In a multi-processing system, multiple processing units execute computer-executable instructions to increase processing power. The memory 3730 may be volatile memory (e.g., registers, cache, RAM), non-volatile memory (e.g., ROM, EEPROM, flash memory, etc.), or some combination of the two. The memory 3730 stores executable software—instructions and data 2250—written and operative to execute and implement the software applications required for an interactive environment supporting practice of the invention.

The computing environment may have additional features. For example, the computing environment 3000 includes storage 3740, one or more input devices 3750, one or more output devices 3760, and one or more communication connections or interfaces 3770. An interconnection mechanism (not shown) such as a bus, controller, or network interconnects the components of the computing environment, for example with servo-mechanisms and sensor devices too sense and control metering pumps, and valves for storing and releasing constituents into and from the mixer. Typically, operating system software (not shown) provides an operating environment for other software executing in the computing environment, and coordinates activities of the components of the computing environment.

The storage 3740 may be removable or non-removable, and includes magnetic disks, CD-ROMs, DVDs, or any other medium which can be used to store information and which can be accessed within the computing environment. The storage 3740 also stores instructions for the software 3720, and is configured, for example, to store signal processing algorithms, intermediate results and data generated from sensor inputs.

The input device(s) 3750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 3760 may be a display, printer, speaker, or another device that provides output from the computing environment.

The communication interface 3770 enable the operating system and software applications to exchange messages over a communication medium with the sensor device, and servo-mechanisms in various instantiations of the apparatus of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 3770 is used to communicate with other devices in a plant for making foam and using foam in the manufacture of concrete. For example, the interface 3770 may be attached to a network, such as the Internet, whereby the computing environment 3000 interchanges command, control and feedback signals with other computers, devices, and machinery, such as concrete trucks that are enabled to communicate.

As an example, the computing environment may be used to control the operation of dispatching and dispensing foam to concrete mixer/transport trucks in a dry-batch concrete plant. The process of dispensing foam can be dramatically enhanced by having at least one batch station, at which the concrete slurry components (i.e., the cement, the aggregate(s), water and any desired dry slurry additives) are introduced into the rotatable drum of the mixer/transport truck as the drum is being rotated. As soon as the slurry components are filly dispensed, the truck departs from the batch station and heads for a foam dispensing station while continuing to mix the slurry components. Upon arriving at the foam dispensing station, the slurry components have been mixed sufficiently for the receipt of the foam. As the foam can be introduced quite rapidly, one foam-dispensing station is able to serve several batch stations. Other liquid additives, which are best dispensed into at least a partially-mixed slurry, may also be dispensed at the foam dispensing station. In order to ensure that each of the mixer/transport trucks receives an allocation of foam that is correct for its particular concrete application, each truck is equipped with a Radio Frequency Identification (RFID) tag, which allows the foam dispensing station equipment to at least identify the truck and determine a correct amount of foam for the particular slurry load.

Assuming the computing environment 3000, the identification procedure functions in the following manner. The batch plant has a computer system that implements the computing environment 3000 on which a database is maintained on the storage 3740. When a mixer/transport arrives at the batch plant, the driver places an order for a particular type and amount of concrete. That order is made a record in the database. An RFID tag having a unique identification code, is identified with the order record in the database. The batch plant computer system communicates with the dispensing equipment at the batch station and at the foam dispensing station. When a mixer/transport truck arrives at the batch station, the RFID tag is queried, the truck is identified, and on the basis of that identification, the order record associated with the truck is called up by the computer, and the batch station dispensing equipment uses the order record information to load the truck with the proper amounts of slurry components required for the ordered load. When the truck later arrives at the foam dispensing station, the RFID tag is again queried, the truck identified, and on the basis of that identification, the foam dispensing equipment dispenses the correct amount of foam for the specific order. Alternatively, smart RFID tags having onboard read/write memory can be employed so that order information taken from the RFID tag during the query steps is used to control the dispensing equipment.

Using Foam Made by the Apparatus and Method

Foam made by the apparatus and method is used in a concrete mixing machine. The concrete mixing machine may be either a tipping, rotating drum at a batch plant or pre-cast concrete manufacturing facility, or the bi-directionally rotating drum of a concrete transport/mixing truck. The concrete mixing machine may also be a pan mixer or drum mixer at a batch plant or pre-cast plant. Measured amounts of Portland cement, aggregates, water and, possibly, other additives are first mixed together to create a slurry in the concrete mixing machine. The foam is added to the slurry after it has been mixed sufficiently so that all of the Portland cement powder has been wet. Once the foam has been uniformly mixed into the slurry, the slurry is poured into forms having a desired shape and allowed to set up as a solid mass, with each bubble of the foam becoming a tiny void in the solid concrete.

### DISCLOSURE SUMMARY

An exemplary embodiment of the invention has been shown and described. It will be obvious to those having ordinary skill in the art that changes and modifications may be made thereto without departing from the scope and the spirit of the invention.

I claim:

1. A method for making foam used to manufacture air entrained or cellular concrete, by mixing constituents, wherein the constituents, per cubic foot of foam made per minute, comprise:
water at not less than sixty-two degrees Fahrenheit, the water mixed at the rate from two-hundred and fifty two ounces per minute to two-thousand one-hundred and seventy-eight ounces per minute;
a chemical comprising a surfactant, a foam booster and a stabilizer, the chemical mixed at a temperature not less than fifty-two degrees Fahrenheit, the chemical mixed at the rate of from twenty-two ounces to seventy-nine ounces; and
air provided at a pressure from sixty-two pounds-per-square inch to one-hundred and thirty-five pounds-per-square inch, at a rate of from nineteen cubic feet per minute to thirty-two cubic feet per minute;
whereby said foam is made from mixing the constituents.

2. An apparatus for making foam used to manufacture concrete, the apparatus comprising:
a mixer for mixing, holding, and delivering said foam, the foam delivered from the mixer according to a first control;
an air container storing air, the air container made and convey air to the mixer according to a second control;
a chemical store, the chemical store made to hold and convey chemical to the mixing device according to a third control;
a water store, the water store made to hold and convey water to the mixer according to a fourth control; and
a controller for controlling air pressure in the air store, water temperature in the water container and for generating said first, second, third and fourth controls, whereby the controller generates the first, second and third controls to control and deliver air, water and chemical to the mixer and make said foam, and the fourth control to deliver foam from the apparatus.

2. The apparatus of claim 2, wherein the second control holds and conveys air to the mixer in the range from 62 pounds per square inch to 135 pounds per square inch.

3. The apparatus of claim 2, wherein the second control holds and conveys air to the mixer in the range from 19 cubic feet per minute to 32 cubic feet per minute.

4. The apparatus of claim 2, wherein the third control holds and conveys surfactant to the mixer when the second control conveys air to the mixer.

5. The apparatus of claim 2, wherein the fourth control conveys water to the mixer at a temperature not less than 62 degrees Fahrenheit.

6. The apparatus of claim 2, wherein the chemical is a non-ionic surfactant.

7. The apparatus of claim 2, wherein the chemical is a fluorinated polymer.

8. An apparatus for making foam used to manufacture concrete, the apparatus comprising:
a mixing device for mixing air, and an aqueous solution, the mixer having a release mechanism controlled by a first signal;
air storage storing air in the range from 62 PSI to 135 PSI, the air storage having an air release mechanism controlled by a second signal;
storage;
a device for receiving and releasing an aqueous solution according to a third signal, wherein the aqueous solution comprises water, a surfactant, a stabilizer and a foam booster; and
a controller for generating said first, second and third signals;
whereby said air and aqueous solution is maintained at a temperature not less than 62 degrees Fahrenheit and released into the mixing device to make said foam, and to release said foam.

9. Foam for use in the manufacture of concrete, the foam made at the rate of one cubic foot per minute, wherein the constituents comprise:
from 252 ounces to 1178 ounces of water at a temperature of at least 62 degrees Fahrenheit;
from 19 cubic feet to 32 cubic feet of air at a pressure of from 62 pounds-per-square-inch to 135 pounds-per-square-inch; and
from 22 ounces to 79 ounces of chemical at a temperature of at least 52 degrees Fahrenheit, the chemical comprising a surfactant, a foam booster and a stabilizer.

10. An apparatus for making foam used to manufacture concrete, the apparatus comprising:
a mixer for mixing, holding, and delivering said foam, the foam delivered from the mixer according to a first control;
an air container storing air, the air container made and convey air to the mixer according to a second control;
a chemical store, the chemical store made to hold and convey chemical to the mixing device according to a third control;
a water store, the water store made to hold and convey water to the mixer according to a fourth control; and
a controller for controlling air pressure in the air store, water temperature in the water container, chemical in the chemical store, and for generating said first, second, third and fourth controls, whereby said controls cause mixing of air, water and chemical constituents according to the method of claim 1.
